(19) United States
(12) Patent Application Publication
(10) Pub. No.: US 2006/0170717 A1
(43) Pub. Date: Aug. 3, 2006

(54) Recording head driving device and printing apparatus

(75) Inventor: Yoshinao Kondoh, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/343,490

(22) Filed: Jan. 31, 2006

(30) Foreign Application Priority Data
Feb. 2, 2005 (JP) 2005-026170

(51) Int. Cl. B41J 29/38

(52) U.S. Cl. 347/5

(57) ABSTRACT

A driving device drives a recording head in which droplet ejection portions are plurally arrayed. The droplet ejection portions include actuating elements which are driven in accordance with driving signals such that droplets are ejected. The driving device is provided with a standard waveform generation section, a voltage amplification section, a plurality of current amplification sections and a selection section. Output terminals of the current amplification sections are commonly connected. The selection section selects at least one of the plurality of current amplification sections, in accordance with the number of the actuating elements to be driven concurrently or a printing density of an image to be printed by the recording head. The selection section inputs a driving signal, whose voltage component has been amplified by the voltage amplification section, to input terminal(s) of the selected current amplification section(s).

### CROSS-REFERENCE TO RELATED APPLICATION

This application claims benefit of and priority to Japanese Patent Application No. 2005-026170, filed on Feb. 2, 2005, which is incorporated herein by reference in its entirety for all purposes.

### BACKGROUND OF THE INVENTION

1. Field of the Invention

The present invention relates to a driving device for a recording head at which droplet ejection portions, which are equipped with actuating elements such that droplets are ejected in accordance with driving signals, are plurally arranged, and to a printing apparatus which includes this recording head.

2. Description of the Related Art

As a recording head which is employed in an inkjet-system printing apparatus, a recording head is known with a form in which droplet ejectors (ink ejection portions) at which respective actuating elements are provided are plurally arranged, and driving signals with predetermined waveforms are applied to the actuating elements, thus altering volumes of pressure generation chambers of the droplet ejectors and ejecting drops of ink from inside the pressure generation chambers.

All the actuating elements are electrically connected in parallel between a common power supply line and an earth line, and predetermined switching elements are electrically connected in series with the respective actuating elements. When, in accordance with printing data, a predetermined switching element is selected and turned on, a driving signal is inputted to the actuating element, and an ink drop is ejected from a nozzle opening of the droplet ejector at which the actuating element to which the driving signal has been inputted is provided. The driving signal has been generated by a standard driving waveform generation circuit, then current-amplified by a current amplification circuit (for example, an A class amplification circuit), and is supplied to the actuating element.

In a printing apparatus which is structured in this manner, because the actuating elements feature capacitance, a head-driving circuit of the printing apparatus has the characteristics of a capacitive load-driving circuit. Consequently, in a conventional printing apparatus, because a capacitance value of the load varies with the number of the droplet ejectors that are ejecting ink drops (i.e., printing density), waveforms of driving signals are disturbed, and problems arise in that sizes of ink drops vary and so forth.

Accordingly, as has been disclosed in Japanese Patent Application Laid-Open (JP-A) No. 11-320872, a capacitive load-driving circuit has been proposed which is provided with capacitive dummy loads in addition to the actuating elements, and which keeps a sum of load capacitances of the actuating elements and the dummy load capacitances constant in order to provide driving signals having consistent waveforms.

However, with this kind of capacitive load driving circuit, it is necessary to supply energy to the dummy loads even when the number of actuating elements to be driven (i.e. the loading capacitance of the actuating elements) is small. As a result, power is consumed excessively. Particularly in recent years, there has been a trend in which the number of droplet ejectors that are provided at heads are increased, in order to realize high-speed printing, and overall power consumption of heads has been increasing. Accordingly, devices which suppress power consumption are in great demand.

Consequently, as devices for responding to loading variations without providing dummy loads, devices which vary the current value of a power supply side have been proposed. For example, a driving device which utilizes a variable constant-current power supply to regulate a waveform, as has been disclosed in JP-A No. 8-112894, a driving device which utilizes a current-limiting element to regulate a waveform, as has been disclosed in JP-A No. 9-187949, and the like are known.

However, even with a device which varies a current value at the current supply side in such a manner, it is necessary to implement fine adjustments of the waveform with an A class amplification circuit or the like. In such a case, because power efficiency of the amplification circuit is low, power consumption amounts are greatly increased. In addition, there is a problem in that heat generation amounts are accordingly increased, so larger radiator plates are necessary, and the device is increased in size. Further still, in such a case, a circuit with a wide frequency range is necessary. However, there are range limitations with simple circuits, and it is difficult to adapt to this requirement.

In order to solve these problems, driving devices in which the current amplification circuit is subdivided have been proposed. For example, a driving device which is provided with a current amplification circuit portion for each of a plurality of rows of nozzles, as has been disclosed in JP-A No. 2003-072063, an inkjet recording device which is provided with a plurality of current amplification sections covering a plurality of heads, as has been disclosed in JP-A Nos. 2000-325882 and 2004-195792, and the like are known.

However, in a driving device which is provided with a current amplification section for each of nozzle row, because the current amplification sections and the nozzle rows are in one-to-one correspondence, output terminals are required for outputting driving signals to the individual nozzles from the individual current amplification circuits. Consequently, a problem arises in that the driving device is increased in size. Further, with an inkjet driving device which is provided with current amplification sections covering a plurality of heads, problems also arise in that distribution of wiring is more complicated and terminals connecting the respective current amplification sections to the respective heads are required, which increases the size of the driving device.

### SUMMARY OF THE INVENTION

The present invention has been devised in consideration of the problems described above, and will provide a recording head driving device and printing apparatus with small size and good energy efficiency, in which waveforms of driving signals are preserved.

A first aspect of the present invention is a recording head driving device for driving a recording head at which droplet ejection portions are plurally arranged, the droplet ejection portions including actuating elements which are driven such that droplets are ejected in accordance with driving signals, the recording head driving device being structured to include: a generation section, which generates a signal with a standard waveform; a voltage amplification section, which amplifies a voltage component of the signal generated by the generation section; a plurality of current amplification sections with output terminals thereby being commonly connected, the plurality of current amplification sections outputting a signal, in which a current component of a signal inputted through an input terminal has been amplified, through the output terminals to serve as a driving signal; and a selection section which, in accordance with the number of the actuating elements to be driven concurrently or a printing density of an image to be printed by the recording head, selects at least one of the plurality of current amplification sections and inputs a signal outputted from the voltage amplification section to the input terminal of selected current amplification section.

A second aspect of the present invention is a recording head driving device for driving a recording head at which droplet ejection portions are plurally arranged, the droplet ejection portions including actuating elements which are driven such that droplets are ejected in accordance with driving signals, the recording head driving device being structured to include: a generation section, which generates a signal with a standard waveform; a plurality of series circuits with output terminals thereof being commonly connected, the plurality of series circuits being structured such that a voltage amplification section and a current amplification section are connected in series in each circuit, the voltage amplification section amplifying a voltage component of the signal generated by the generation section, and the current amplification section amplifying a current component of the signal whose voltage component has been amplified by the voltage amplification section and outputting through the output terminal to serve as a driving signal; and a selection section which, in accordance with the number of the actuating elements to be driven concurrently or a printing density of an image to be printed by the recording head, selects at least one from the plurality of series circuits and inputs the signal generated by the generation section to an input terminal of selected series circuit.

A third aspect of the present invention is a recording head driving device for driving a recording head at which droplet ejection portions are plurally arranged, the droplet ejection portions including actuating elements which are driven such that droplets are ejected in accordance with driving signals, the recording head driving device being structured to include: a plurality of series circuits with output terminals thereof being commonly connected, the plurality of series circuits being structured such that a generation section, a voltage amplification section and a current amplification section are connected in series in each circuit, the generation section generating a signal with a standard waveform in accordance with an input of a generation signal, the voltage amplification section amplifying a voltage component of the signal generated by the generation section, and the current amplification section amplifying a current component of the signal whose voltage component has been amplified by the voltage amplification section and outputting through the output terminal to serve as a driving signal; and a selection section which, in accordance with the number of the actuating elements to be driven concurrently or a printing density of an image to be printed by the recording head, selects at least one from the plurality of series circuits and inputs the generation signal to an input terminal of selected series circuit.

A fourth aspect of the present invention is a recording head driving device for driving a recording head at which droplet ejection portions are plurally arranged, the droplet ejection portions including actuating elements which are driven such that droplets are ejected in accordance with driving signals, the recording head driving device being structured to include: a digital waveform generation section, which generates a signal with a standard digital waveform; a plurality of series circuits with output terminals thereof being commonly connected, the plurality of series circuits being structured such that an analog waveform generation section, a voltage amplification section and a current amplification section are connected in series in each circuit, the analog waveform generation section generating a signal with an analog waveform from the signal generated by the digital waveform generation section, the voltage amplification section amplifying a voltage component of the signal generated by the analog waveform generation section, and the current amplification section amplifying a current component of the signal whose voltage component has been amplified by the voltage amplification section and outputting through the output terminal to serve as a driving signal; and a selection section which, in accordance with the number of the actuating elements to be driven concurrently or a printing density of an image to be printed by the recording head, selects at least one from the plurality of series circuits and inputs the signal generated by the digital waveform generation section to an input terminal of selected series circuit.

Further, a fifth aspect of the present invention is a printing apparatus structured to include: a recording head at which droplet ejection portions are plurally arranged, the droplet ejection portions including actuating elements which are driven such that droplets are ejected in accordance with driving signals; and a recording head driving device for driving the recording head which includes a generation section, which generates a signal with a standard waveform, a voltage amplification section, which amplifies a voltage component of the signal generated by the generation section, a plurality of current amplification sections with output terminals thereby being commonly connected, the plurality of current amplification sections outputting a signal, in which a current component of a signal inputted through an input terminal has been amplified, through the output terminals to serve as a driving signal, and a selection section which, in accordance with the number of the actuating elements to be driven concurrently or a printing density of an image to be printed by the recording head, selects at least one of the plurality of current amplification sections and inputs a signal outputted from the voltage amplification section to each input terminal of selected current amplification section.

### BRIEF DESCRIPTION OF THE DRAWINGS

Preferred embodiments of the present invention will be described in detail based on the following figures, wherein:

FIG. 1A is a schematic perspective view of a recording head of a present embodiment;

FIG. 1B is a plan view of a head unit which structures the recording head;

FIG. 2 is a schematic sectional view describing structure of a droplet ejector;

FIG. 3 is a structural diagram of a driving device which drives the recording head;

FIG. 4 is a structural diagram of a waveform preparation circuit;

FIG. 5 is a diagram showing structure of the waveform preparation circuit illustrated in FIG. 4 in a simple block diagram;

FIG. 6 is a diagram showing a variant example of a selection section of the waveform preparation circuit;

FIG. 7 is a diagram showing a variant example of the waveform preparation circuit;

FIG. 8 is a diagram showing a variant example of the waveform preparation circuit; and

FIG. 9 is a diagram showing a variant example of the waveform preparation circuit.

### DETAILED DESCRIPTION OF THE INVENTION

Herebelow, an embodiment of the present invention will be described in detail with reference to the drawings. A printing apparatus of the present embodiment is equipped with a recording head and a driving device.

The recording head driving device thereof drives the recording head, at which droplet ejection portions including actuating elements are plurally arranged, the actuating elements being driven such that droplets are ejected in accordance with driving signals.

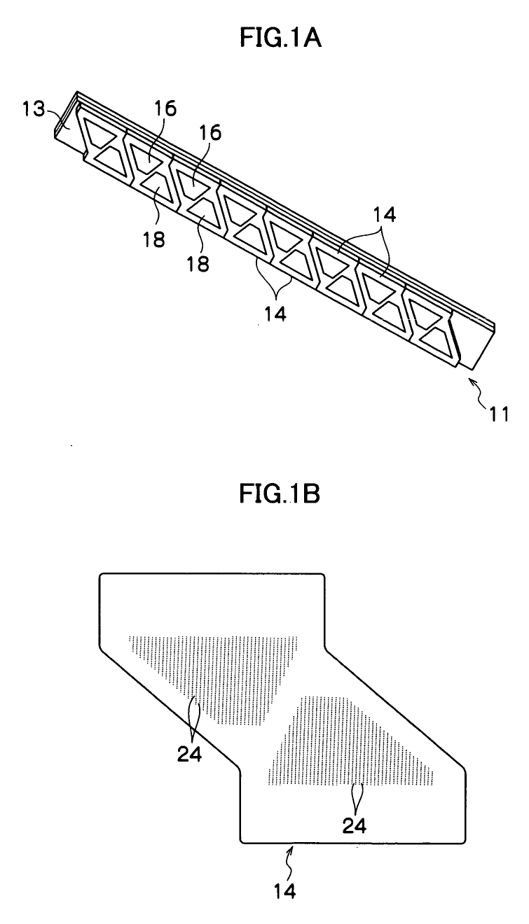

FIG. 1A is a schematic perspective view of a recording head 11 which is provided at the printing apparatus of the present embodiment, and FIG. 1B is a plan view of a head unit 14 which structures the recording head 11. As shown in FIG. 1A, the recording head 11 is equipped with a head bar 13, which is specified with a length corresponding to a maximum width of a recording medium. At this head bar 13, a plurality of the head unit 14 are joined together in a row and arranged in two dimensions. As shown in FIG. 1B, two ejector units 16 and 18 are arranged at a substantially parallelogram-shaped portion of each head unit 14. The ejector units 16 and 18 are formed with numerous droplet ejectors 24 for ejecting ink. Each of the ejector units 16 and the ejector units 18 is structured by, for example, 512 of the droplet ejectors 24, which are two-dimensionally arranged into 32 rows, so as to be non-symmetrical in a left-right direction. Further, the ejector units 16 and 18 have substantially trapezoid shapes, and are arranged in the head unit 14 such that diagonal sides of the substantially trapezoid shapes which have equal lengths (in the present embodiment, shorter diagonal sides) oppose one another. At each of two sides of the head unit 14, supply apertures (not shown) are provided for supplying ink to the ejector units 16 and 18.

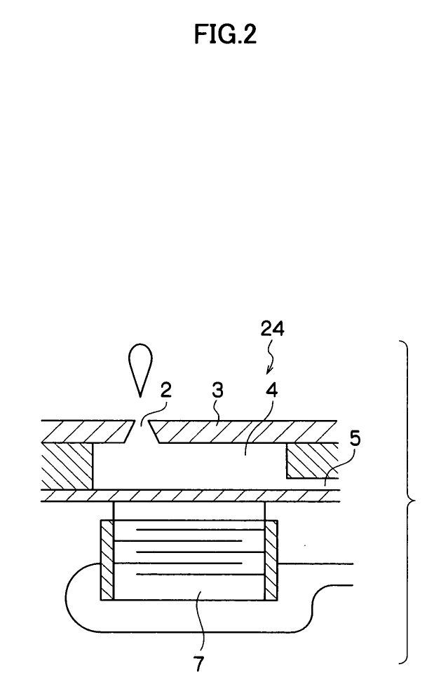

FIG. 2 is a sectional schematic view describing structure of the droplet ejectors 24. Each of the droplet ejectors 24 is structured by a nozzle plate 3, a pressure generation chamber 4, an ink supply channel 5 and an actuator 7. A plurality of nozzle 2 is formed in each nozzle plate 3. The pressure generation chamber 4 is provided in correspondence with the nozzle 2 and is charged with ink which is to be ejected through the nozzle 2. The ink supply channel 5 supplies ink from an unillustrated ink tank to the pressure generation chamber 4. The actuator 7 is provided in correspondence with the pressure generation chamber 4. When the actuator 7 is driven, the pressure generation chamber 4 expands/contracts, volume of the pressure generation chamber 4 is altered by a predetermined amount by this expansion/contraction and, at this time, the ink charged into the pressure generation chamber 4 is ejected through the nozzle 2.

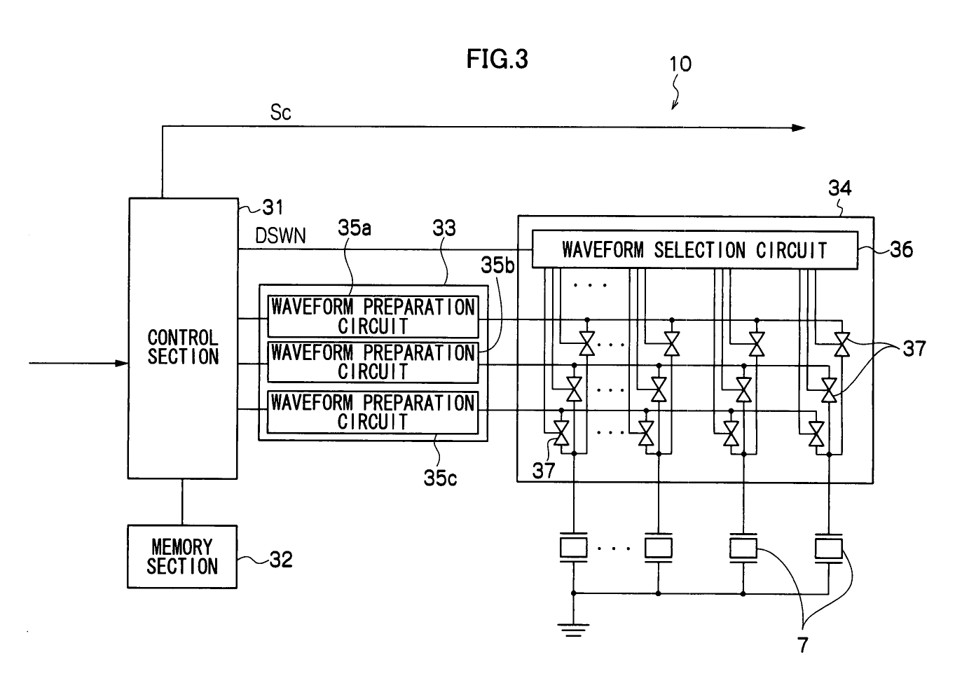

FIG. 3 is a structural diagram of a driving device 10, which drives the recording head 11.

As shown in FIG. 3, the driving device 10 includes a waveform preparation section 33, a memory section 32, a switching section 34 and a control section 31. The waveform preparation section 33 prepares driving signals with a plurality of types of waveform. The memory section 32 has memorized data which is required for driving the waveform preparation section 33 beforehand. The switching section 34 switches driving signals to be supplied to the actuators 7 provided at the respective droplet ejectors 24. The control section 31 performs control of driving of each section and of sending/receiving of various signals.

The waveform preparation section 33 includes three waveform preparation circuits 35a, 35b and 35c, for preparing the plurality of types of waveform. Here, the three waveform preparation circuits 35a, 35b and 35c have similar structures. Accordingly, a case will be described in which these are not particularly distinguished from one another, but are referred to as a waveform preparation circuit 35, with the suffixes of the reference numeral being omitted.

At the recording head 11, when waveform data corresponding to ink droplets of different diameters (large drops, medium drops and small drops) is supplied to the waveform preparation circuits 35a, 35b and 35c, the driving signals of the three types of waveform are simultaneously generated and ink drops of the three different diameters can be simultaneously printed (tone printing). This waveform data has been memorized at the memory section 32, and is provided to the waveform preparation circuits 35a, 35b and 35c via the control section 31.

Herein, waveform data for non-ejection of an ink drop is also memorized at the memory section 32. This waveform data is data for generating a driving signal for agitating the ink in the pressure generation chamber 4 with pressure in an amount which will not eject an ink drop, in order to prevent variations in ejection characteristics due to contact between the ink and air at a vicinity of the nozzle 2 and thickening of the ink. This driving signal for non-ejection of an ink drop is employed with being combined in a time series with the driving signals for any of large drops, medium drops and small drops.

Each of the waveform preparation circuits 35a, 35b and 35c is connected by signal lines with the actuators 7 provided at the respective droplet ejectors 24. In order to supply one of the driving signals with mutually differing waveforms which are prepared by the waveform preparation circuits 35a, 35b and 35c to the actuators 7, switches 37 are provided between the signal lines and the actuators 7. By on/off switching of these switches 37, for each actuator 7, one driving signal from the driving signals prepared by the waveform preparation circuits 35a, 35b and 35c can be selected and supplied to the actuator 7. The on/off switching of the switches 37 is implemented by a waveform selection circuit 36 of the switching section 34, on the basis of instruction signals DSWN from the control section 31. Thus, driving of the actuators 7 is controlled.

The control section 31, in addition to controlling each section described above and the sending/receiving of the various signals, outputs driving instruction signals SC for a driving motor (not shown), which is for turning a paper conveyance roller which conveys paper for printing.

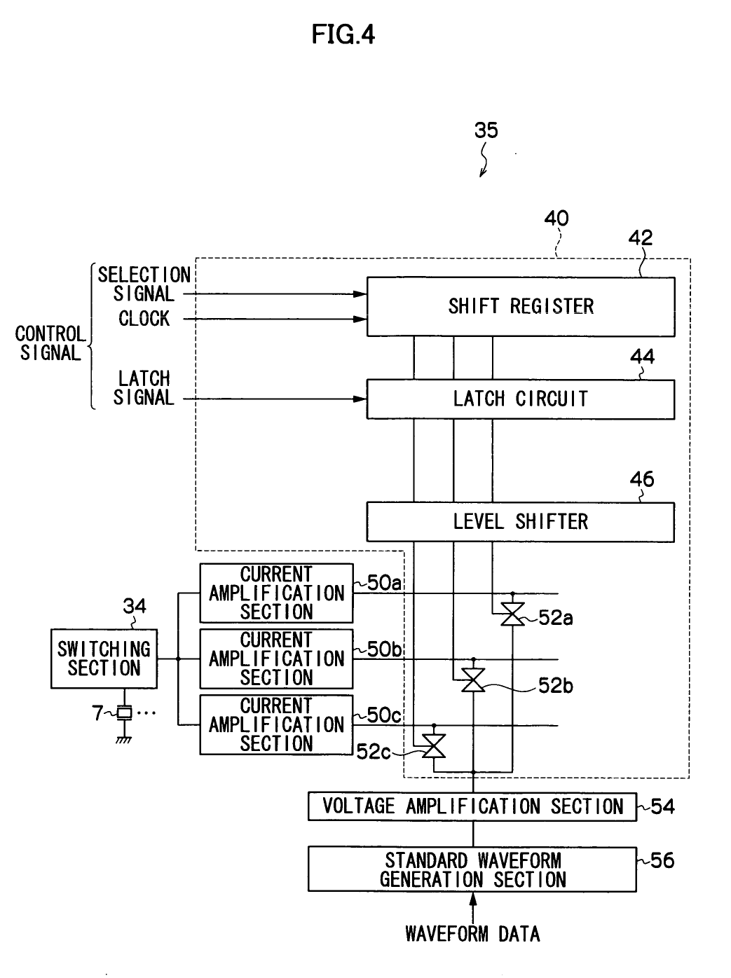

FIG. 4 is a structural diagram of the waveform preparation circuit 35. As shown in FIG. 4, the waveform preparation circuit 35 is equipped with a standard waveform generation section 56, a voltage amplification section 54, a plurality of current amplification sections 50a, 50b and 50c, and a selection section 40.

The standard waveform generation section 56 generates a driving signal with a standard waveform on the basis of waveform data which is inputted from the control section 31.

The voltage amplification section 54 amplifies a voltage component of the driving signal that is generated by the standard waveform generation section 56.

The plurality of current amplification sections 50a, 50b and 50c, when the driving signal whose the voltage component has been amplified is inputted thereto, amplify the current component of the driving signal. In the present embodiment, each of the current amplification sections 50a, 50b and 50c has the same structure, and amplification ratios thereof are equal. Herebelow, a case will be described in which these are not particularly distinguished from one another, but are referred to as a current amplification section 50, with the suffixes of the reference numeral being omitted.

Output terminals of the respective current amplification sections 50 are commonly connected, and are connected to all of the actuators 7 via the switching section 34. Thus, it is possible to unify the driving signals which have been current-amplified by the current amplification sections 50 and output the unified driving signal to the actuators 7.

The selection section 40 is a single-input, multiple-output switching circuit. When a driving signal which has been voltage-amplified by the voltage amplification section 54 is inputted, at least one current amplification section 50 is selected from the plurality of current amplification sections 50, and the voltage-amplified driving signal is outputted to the input terminal(s) of the selected current amplification section(s) 50. Of the plurality of current amplification sections 50, each current amplification section 50 to which the driving signal has been inputted amplifies the current component of the driving signal and outputs the same through the output terminal thereof. Here, because the current amplification sections 50 all have the same amplification ratio, it is possible to regulate the current component of the driving signal that is supplied to the actuators 7 by regulating the number of the current amplification sections 50 to be selected.

Here, because the current amplification sections 50 that have not been selected are in a driving-paused state, power consumption can be correspondingly suppressed. Note that the selection of the current amplification sections 50 is controlled by control signals from the control section 31.

As shown in FIG. 4, the selection section 40 is structured by a shift register 42, a latch circuit 44, a level shifter 46, and switches 52a, 52b and 52c.

As shown in FIG. 4, a control signal from the control section 31 is structured to include a selection signal, a clock signal and a latch signal. The selection signal and the clock signal are inputted to the shift register 42, and the latch signal is inputted to the latch circuit 44.

The selection signal is a signal for selecting the current amplification section(s) 50 to be driven, and is a serial signal composed of an a-selection signal, a b-selection signal and a c-selection signal. Each selection signal is one bit of data, which is a ‘0’ or a ‘1’. The current amplification section 50a is not selected when the a-selection signal is ‘0’, and is selected when the a-selection signal is ‘1’. The current amplification section 50b is not selected when the b-selection signal is ‘0’, and is selected when the b-selection signal is ‘1’. The current amplification section 50c is not selected when the c-selection signal is ‘0’, and is selected when the c-selection signal is ‘1’.

The shift register 42 converts the inputted selection signal, which is three bits of serial data, to three bits of parallel data and outputs the same to the latch circuit 44.

The latch circuit 44 latches (self-maintains) the parallel data outputted from the shift register 42, in accordance with input of the latch signal.

The level shifter 46 level-converts the respective selection signals from the latch circuit 44, and outputs the level-converted selection signals to the respective switches 52a, 52b and 52c. In accordance with these selection signals, the switches 52a, 52b and 52c are respectively turned on or off, and the driving signal that has been voltage-amplified by the voltage amplification section 54 is fed to the current amplification sections 50 that are connected to the switches 52 that are switched on. Thus, it is possible to selectively drive the current amplification sections 50. Here, because the driving signal is not inputted to the current amplification sections 50 that are connected to the switches 52 that are turned off, those current amplification sections 50 are in the driving-paused state, and power consumption can be suppressed.

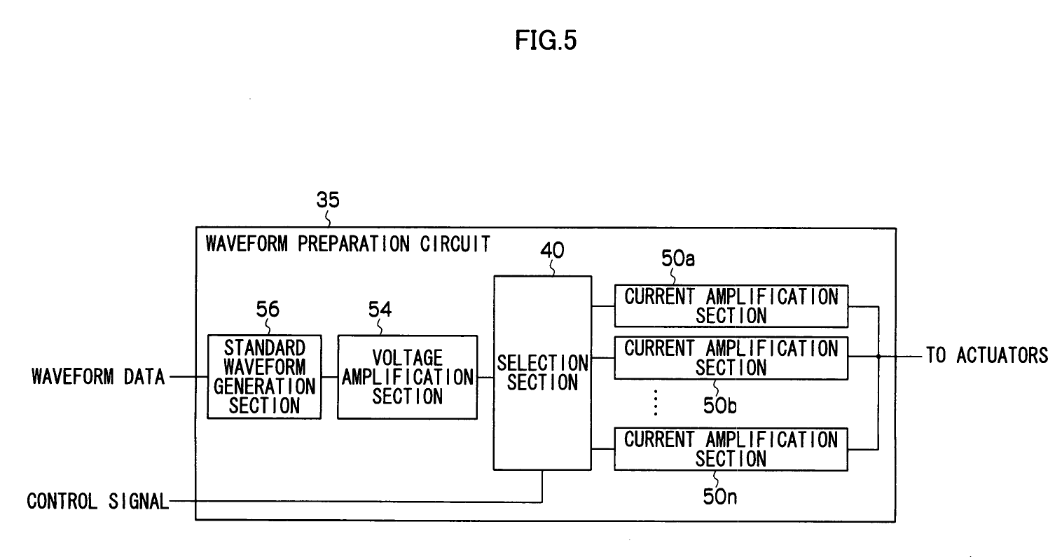

FIG. 5 is a diagram showing the waveform preparation circuit 35 illustrated in FIG. 4 in a simple block diagram. As is clear from FIG. 5, the waveform preparation circuit 35 is provided with the standard waveform generation section 56, the voltage amplification section 54, the selection section 40 and the plurality of current amplification sections 50, and the selection section 40 is disposed prior to the current amplification sections 50. Further, the output terminals of the current amplification sections 50 are commonly connected and are connected to the actuators 7 via the switching section 34.

Next, operations of the driving device 10 relating to the present embodiment will be described.

The control section 31, in accordance with printing data which includes tone information, which is supplied from outside, determines whether to supply one of the driving signals of the three types of waveform which have been prepared by the three waveform preparation circuits 35a, 35b and 35c, or not to supply any of the driving signals, to the actuators 7, and sends waveform selection signals to the waveform selection circuit 36 in order to switch the switches 37 on and off.

Then, when a printing commencement instruction is supplied from outside, the control section 31 reads the waveform data corresponding to each waveform preparation circuit 35 from the memory section 32 and outputs the same to the standard waveform generation section 56 of each waveform preparation circuit 35, and outputs the control signal for selectively driving the current amplification sections 50 to the selection section 40 of the waveform preparation circuit 35.

As described above, the control signal is structured to include the selection signal, the clock and the latch signal. Of these, the selection signal is generated as described below and outputted.

A loading capacitance value varies in accordance with the number of the actuators 7 that are being driven at one time (a concurrent driving count). Accordingly, herein, in order to suppress disturbance of a driving signal waveform due to variations in loading capacitance values, a driving count of the current amplification sections 50 (a number of the current amplification sections 50 to which the driving signal which has been amplified by the voltage amplification section 54 is inputted) is varied in correspondence with the concurrent driving count of the actuators 7. Thus, the current component of the driving signal which is outputted at the commonly connected output terminals of the current amplification sections 50 is adjusted, and disturbance of the waveform is prevented.

Now, when a printing density represented by the printing data is low, the concurrent driving count of the actuators 7 is small, and when the printing density is high, the concurrent driving count of the actuators 7 is large. Therefore, it is also possible to determine the number of current amplification sections 50 to be selected in accordance with printing densities.

Specifically, when the printing density is low (i.e., the concurrent driving count of the actuators 7 is to be small), the selection signal is generated and outputted such that the number of the current amplification sections 50 selected by the selection section 40 is small (i.e., such that the current component of the driving signal supplied to the actuators 7 is small). Further, when the printing density is high (i.e., the concurrent driving count of the actuators 7 is to be large), the selection signal is generated and outputted such that the number of the current amplification sections 50 selected by the selection section 40 is large (i.e., such that the current component of the driving signal supplied to the actuators 7 is large).

Herein, a table in which printing densities are corresponded with selection numbers of the current amplification sections 50 may be memorized beforehand at the memory section 32. On the basis of this table, selection numbers corresponding to printing densities derived from printing data may be read out and selection signals are generated. It is also possible to generate selection signals by deriving selection numbers of the current amplification sections 50 with a function in which printing density is a parameter.

When the standard waveform generation section 56 of the waveform preparation circuit 35 inputs waveform data from the control section 31, a driving signal is generated with a waveform in accordance with the waveform data, and is outputted to the voltage amplification section 54. The voltage amplification section 54 amplifies the voltage component of the driving signal that has been generated by the standard waveform generation section 56, by a predetermined amplification ratio, and outputs the waveform whose voltage component has been amplified to the selection section 40.

The selection section 40 selects at least one, or more, of the current amplification sections 50 in accordance with the selection signal from the control section 31, and inputs the driving signal whose voltage component has been amplified by the voltage amplification section 54 to the selected current amplification section(s) 50.

The current amplification section 50 to which the driving signal is inputted amplifies the current component of the inputted driving signal, and outputs the driving signal through the output terminal. Because the output terminals of the current amplification sections 50 are commonly connected as mentioned above, the current-amplified driving signals are unified for output to the switching section 34. The switching section 34 supplies the driving signal that has been current-amplified by the current amplification section(s) 50 selected by the selection section 40 to the actuators 7 in which the switches 37 corresponding to each respective waveform preparation circuit 35 are turned on.

Thus, it is possible to vary the selection numbers of the pluralities of current amplification sections 50 in accordance with printing densities (concurrent driving numbers of the actuators 7). Therefore, it is possible to appropriately adjust the current components of the driving signals in accordance with load variations, without providing dummy loads, and waveform regulation over a broad frequency range is facilitated. Further, with such a structure, because there is no need for large radiator plates for suppressing heating amounts, it is possible to prevent an increase in size of the device. Further still, because the output terminals of the current amplification sections 50 for the respective actuating elements are commonly connected, wiring distribution is not made more complicated and it is possible to restrain size of the device.

Further again, because the current amplification sections 50 which are not selected by the selection section 40 are in a driving-paused state, power consumption can be correspondingly suppressed.

Now, in the embodiment described above, a case in which three of the current amplification sections 50 are provided at the waveform preparation circuit 35 has been described as an example. However, the number of current amplification sections 50 is not particularly limited to three, and may be four or more. For example, it is possible to provide small-scale current amplification portions, at which large radiator plates are not required, in a number that is sufficient for providing a required range.

Furthermore, for the embodiment described above, a case in which the current amplification sections 50 whose current amplification ratios are the same are plurally provided has been described as an example. However, this is not limiting. For example, the amplification ratios of the current amplification sections 50 may be different. For example, the current amplification sections 50 could be designed with a smallest amplification ratio of 1, with the other amplification ratios being second powers (that is, ×1, ×2, ×4, . . . ). When the current amplification sections 50 are plurally provided with amplification ratios which differ in such a manner, the current components of driving signals can be altered (amplified) to desired values by combinations of the current amplification sections 50. Note that in such a case too, it is possible, for example, to memorize a table in which the image printing densities are associated with types of the current amplification sections 50 to be selected, at the memory section 32 beforehand, and to select the current amplification sections 50 of types corresponding to printing densities which are derived from printing data on the basis of this table.

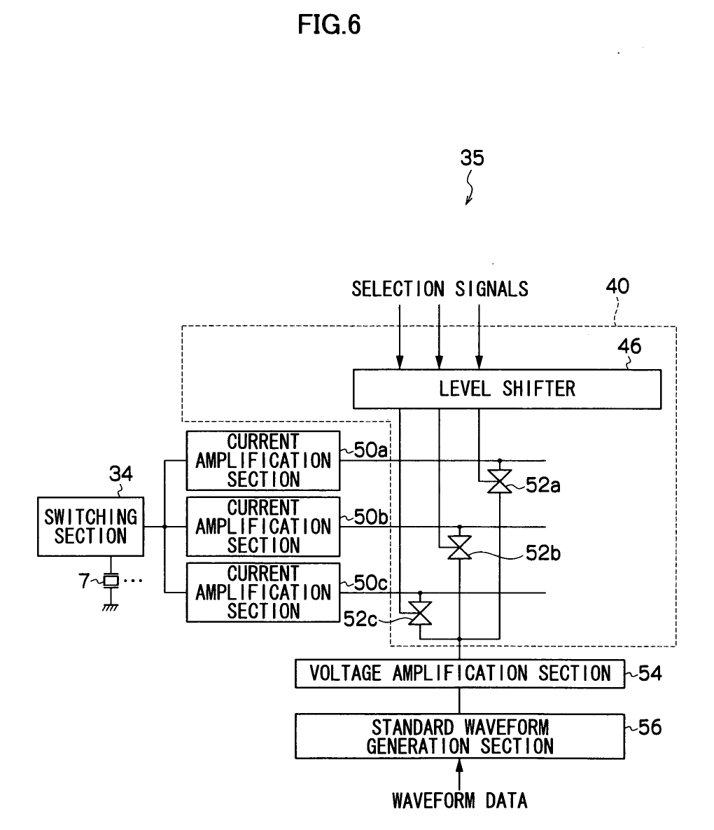

Further yet, for the embodiment described above, an example has been described in which the selection section 40 is structured by the shift register 42, the latch circuit 44, the level shifter 46 and the switches 52. However, in a case in which the number of current amplification sections 50 is small, the selection section 40 may be structured by the level shifter 46 and the switches 52 for example, as shown in FIG. 6. In such a case, input signal lines for inputting selection signals from the control section 31 are provided to the level shifter 46 in the same number as the current amplification sections 50. Hence, it is possible to input the selection signals for selecting the current amplification sections 50 to the level shifter 46 in parallel.

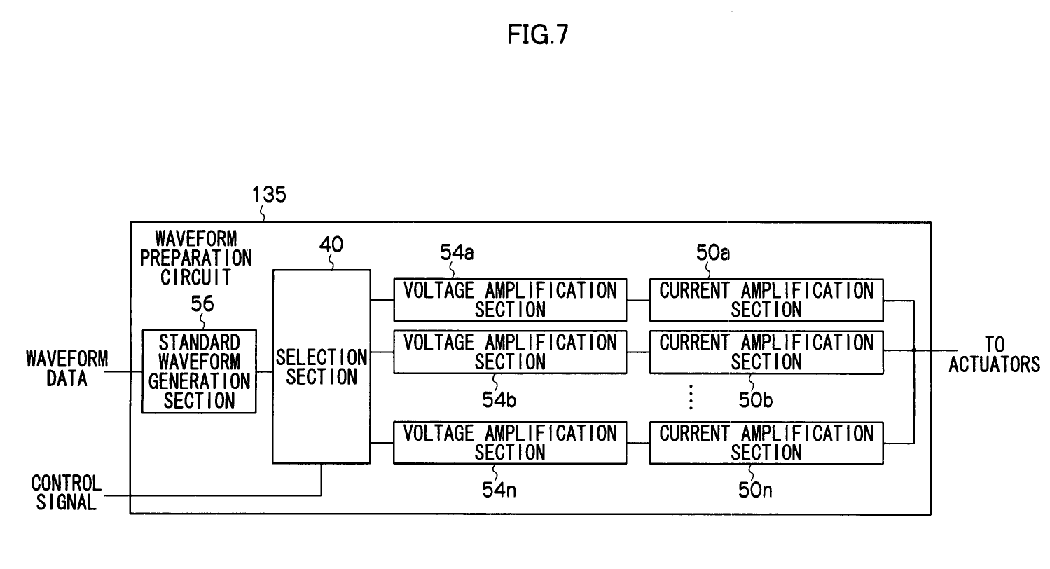

Next, variant examples of the embodiment described above will be described with reference to FIGS. 7 to 9.

For the embodiment described above, an example has been described of a waveform preparation circuit at which only one of the voltage amplification section 54 is provided. However, as shown in FIG. 7, the recording head driving device may be structured to include: the standard waveform generation section 56, which generates the driving signal with the standard waveform; a plurality of series circuits in each of which the voltage amplification section 54 and the current amplification section 50 are connected in series, the voltage amplification section 54 amplifying the voltage component of the signal which has been generated by the standard waveform generation section 56, and the current amplification section 50 amplifying the current component of the signal whose voltage component has been amplified by the voltage amplification section 54 and outputting the signal whose current component has been amplified to serve as the driving signal for driving the actuating elements; and the selection section 40. In the case of such a structure, the selection section 40 is disposed subsequent to the standard waveform generation section 56 and prior to the plurality of voltage amplification sections 54. Further, the same as described before, the output terminals of the current amplification sections 50 (i.e., output terminals of the series circuits) are commonly connected, and are connected to the actuators 7 via the switching section 34. Here, structures of the respective voltage amplification sections 54 may be the same.

With such a waveform preparation circuit 135, the selection section 40 selects at least one among the plurality of series circuits in accordance with a concurrent driving count of the actuators 7 or a printing density, and inputs the driving signal generated by the standard waveform generation section 56 to the input terminal(s) of the selected series circuit(s). The voltage amplification section 54 to which the driving signal is inputted amplifies the voltage component of the driving signal and outputs the same. When the driving signal outputted from the voltage amplification section 54 is inputted to the current amplification section 50 to which the voltage amplification section 54 is connected in series, the current amplification section 50 amplifies the current component of the driving signal. With this structure too, it is possible to adjust the current component of the driving signal in accordance with loading variations, and it is possible to regulate the waveform of the driving signal. Further, because the series circuits which are not selected are in a driving-paused state, it is possible to suppress power consumption accordingly. Further, with this structure too, wiring is not made particularly complicated. Therefore, size of the apparatus will not be increased.

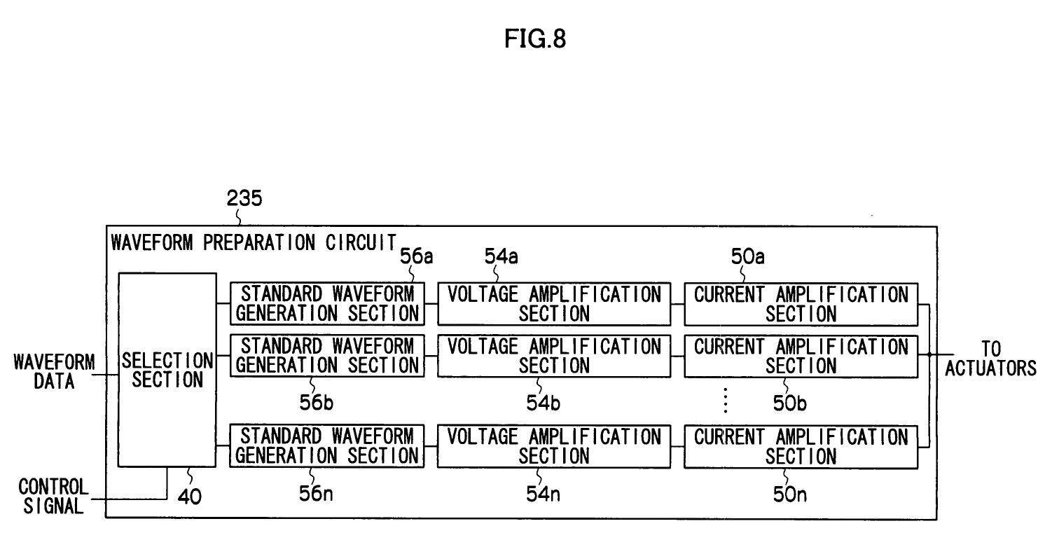

Further again, as shown in FIG. 8, the recording head driving device may be structured to include: a plurality of series circuits which are each structured by the standard waveform generation section 56, the voltage amplification section 54 and the current amplification section 50 being connected in series, the standard waveform generation section 56 generating the driving signal with the standard waveform, the voltage amplification section 54 amplifying the voltage component of the signal which has been generated by the standard waveform generation section 56, and the current amplification section 50 amplifying the current component of the signal whose voltage component has been amplified by the voltage amplification section 54 and outputting the signal whose current component has been amplified to serve as the driving signal for driving the actuating elements; and the selection section 40. In the case of such a structure, the selection section 40 is disposed prior to the standard waveform generation sections 56. Further, similarly to the variant example described above, the output terminals of the current amplification sections 50 (i.e., output terminals of the series circuits) are commonly connected, and are connected to the actuators 7 via the switching section 34. Here, structures of the respective standard waveform generation sections 56 and the respective voltage amplification sections 54 may be the same.

With such a waveform preparation circuit 235, the selection section 40 selects at least one among the plurality of series circuits in accordance with a concurrent driving count of the actuators 7 or a printing density, and inputs waveform data from the control section 31 to the input terminal(s) of the selected series circuit(s). The standard waveform generation sections 56 at which the waveform data is inputted generates and outputs the driving signal. When the driving signal from the standard waveform generation section 56 is inputted to the voltage amplification section 54 to which the standard waveform generation section 56 is connected in series, the voltage amplification section 54 amplifies the voltage component of the driving signal and outputs the signal whose voltage component has been amplified. When the driving signal from the voltage amplification section 54 is inputted to the current amplification section 50 to which the voltage amplification section 54 is connected in series, the current amplification section 50 amplifies the current component of the driving signal.

With this structure too, it is possible to adjust the current component of the driving signal in accordance with loading variations, and it is possible to regulate the waveform of the driving signal. Further, because the series circuits which are not selected are in the driving-paused state, it is possible to suppress power consumption accordingly. Further, with this structure too, wiring is not made particularly complicated. Therefore, size of the apparatus will not be increased.

In a recording head driving device of the structures described above, each generation section may be structured by: a digital waveform generation section, which generates a signal with a standard digital waveform; and an analog waveform generation section, which generates a signal with an analog waveform from the signal generated by the digital waveform generation section.

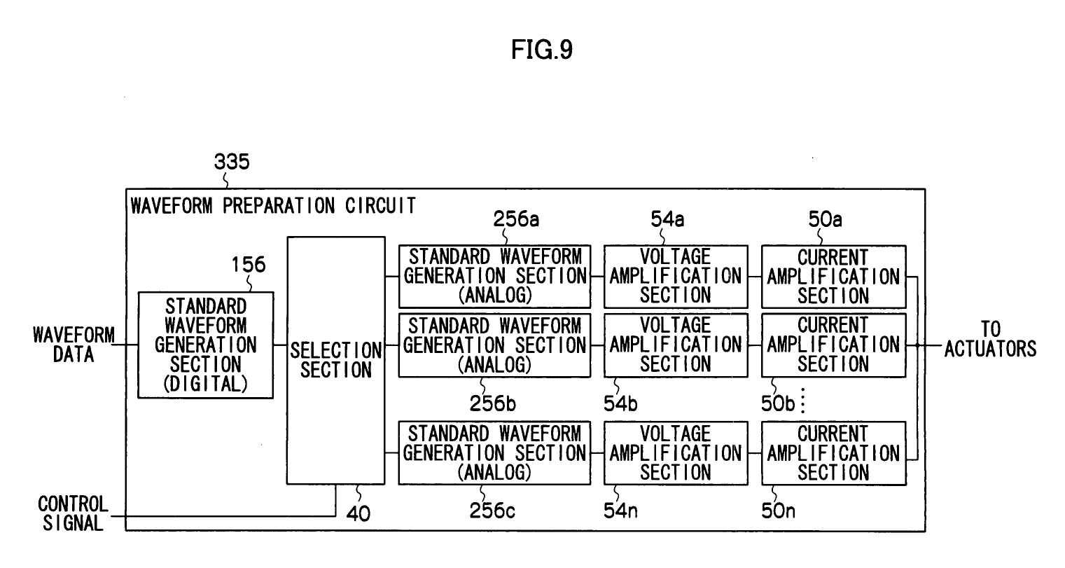

Further, as shown in FIG. 9, the recording head driving device may be structured to include: a digital standard waveform generation section 156, which generates a driving signal with a digital waveform; a plurality of series circuits which are each structured by an analog standard waveform generation section 256, the voltage amplification section 54 and the current amplification section 50 being connected in series, the analog standard waveform generation section 256 generating an analog waveform signal from the signal generated by the digital standard waveform generation section 156, the voltage amplification section 54 amplifying the voltage component of the signal which has been generated by the analog standard waveform generation section 256, and the current amplification section 50 amplifying the current component of the signal whose voltage component has been amplified by the voltage amplification section 54 and outputting the signal whose current component has been amplified to serve as the driving signal for driving the actuating elements; and the selection section 40. In the case of such a structure, the selection section 40 is disposed prior to the analog standard waveform generation sections 256. Further, similarly to the variant examples described above, the output terminals of the current amplification sections 50 (i.e., output terminals of the series circuits) are commonly connected, and are connected to the actuators 7 via the switching section 34. Here, structures of the respective analog standard waveform generation sections 256 and the respective voltage amplification sections 54 may be the same.

With such a waveform preparation circuit 335, the selection section 40 selects at least one among the plurality of series circuits in accordance with a concurrent driving count of the actuators 7 or a printing density, and inputs the driving signal generated by the digital standard waveform generation section 156 to the input terminal(s) of the selected series circuit(s).

The analog standard waveform generation section 256 at which the digital waveform driving signal is inputted generates and outputs the analog waveform driving signal. When the driving signal from the analog standard waveform generation section 256 is inputted to the voltage amplification section 54 to which the analog standard waveform generation section 256 is connected in series, the voltage amplification section 54 amplifies the voltage component of the driving signal and outputs the signal whose voltage component has been amplified. When the driving signal from the voltage amplification section 54 is inputted to the current amplification section 50 to which the voltage amplification section 54 is connected in series, the current amplification section 50 amplifies the current component of the driving signal.

With this structure too, it is possible to adjust the current component of the driving signal in accordance with loading variations, and it is possible to regulate the waveform of the driving signal. Further, because the series circuits which are not selected are in the driving-paused state, it is possible to suppress power consumption accordingly. Further, with this structure too, wiring is not made particularly complicated. Therefore, size of the apparatus will not be increased.

Anyway, for the embodiment including the variant examples described above, examples have been described of printing apparatuses (recording heads) at which waveform preparation circuits are plurally provided and which are capable of performing tone printing. However, the waveform preparation circuit may be provided singly at a recording head (which will not perform tone printing), and is not particularly limited.

Note that structures of the recording head driving device are not particularly limited as long as the structures realize the functions of the present invention. For example, structures are possible in which the functions are separated, being divided between a circuit which features a voltage amplification function and a circuit which features a current amplification function, structures are possible in which the voltage amplification function and the current amplification function are integrated as a power amplification circuit, and structures are not particularly limited.

For the embodiment described earlier, a case in which ink is employed as droplets has been described as an example. However, the present invention is not limited thus. Instead of ink, for example, a reaction fluid could be employed. A reaction fluid is a fluid which is employed for, for example, promoting solidification of ink droplets which have been ejected or the like. More specifically, a mixing of ink droplets with the reaction fluid droplets on a recording medium improves image quality. Therefore, when reaction fluid droplets are to be ejected by droplet ejectors, the present invention can be employed in the same manner as described above. Further, with the inkjet process, the present invention can be applied in the same manner as described above to application of an orientation film formation material for liquid crystal displaying elements, application of flux, application of adhesive, and so forth.

Further, the recording head which is driven by each of the inventions described above may be a recording head for an FWA (full width array) system printing apparatus, in which recording is performed while only a recording medium is being conveyed, with the recording head staying fixed, and may be a recording head for a PWA (partial width array) system printing apparatus, which prints by moving the recording head in a main scanning direction while moving recording paper in a sub-scanning direction.

According to the invention as explained hereabove, excellent effects are achieved in that it is possible to prevent distortions of a driving signal waveform due to loading variations, without providing dummy loads, and it is possible to suppress power consumption and an increase in size of an apparatus.

What is claimed is:

1. A recording head driving device for driving a recording head at which droplet ejection portions are plurally arranged, the droplet ejection portions including actuating elements which are driven such that droplets are ejected in accordance with driving signals, the recording head driving device comprising:
a generation section, which generates a signal with a standard waveform;
a voltage amplification section, which amplifies a voltage component of the signal generated by the generation section;
a plurality of current amplification sections with output terminals thereby being commonly connected, the plurality of current amplification sections outputting a signal, in which a current component of a signal inputted through an input terminal has been amplified, through the output terminals to serve as a driving signal; and
a selection section which, in accordance with the number of the actuating elements to be driven concurrently or a printing density of an image to be printed by the recording head, selects at least one of the plurality of current amplification sections and inputs a signal outputted from the voltage amplification section to each input terminal of selected current amplification section.

2. A recording head driving device for driving a recording head at which droplet ejection portions are plurally arranged, the droplet ejection portions including actuating elements which are driven such that droplets are ejected in accordance with driving signals, the recording head driving device comprising:
a generation section, which generates a signal with a standard waveform;
a plurality of series circuits with output terminals thereof being commonly connected, the plurality of series circuits being structured such that a voltage amplification section and a current amplification section are connected in series in each circuit, the voltage amplification section amplifying a voltage component of the signal generated by the generation section, and the current amplification section amplifying a current component of the signal whose voltage component has been amplified by the voltage amplification section and outputting the signal whose current component has been amplified through the output terminal to serve as a driving signal; and
a selection section which, in accordance with the number of the actuating elements to be driven concurrently or a printing density of an image to be printed by the recording head, selects at least one from the plurality of series circuits and inputs the signal generated by the generation section to each input terminal of selected series circuit.

3. A recording head driving device for driving a recording head at which droplet ejection portions are plurally arranged, the droplet ejection portions including actuating elements which are driven such that droplets are ejected in accordance with driving signals, the recording head driving device comprising:
a plurality of series circuits with output terminals thereof being commonly connected, the plurality of series circuits being structured such that a generation section, a voltage amplification section and a current amplification section are connected in series in each circuit, the generation section generating a signal with a standard waveform in accordance with an input of a generation signal, the voltage amplification section amplifying a voltage component of the signal generated by the generation section, and the current amplification section amplifying a current component of the signal whose voltage component has been amplified by the voltage amplification section and outputting the signal whose current component has been amplified through the output terminal to serve as a driving signal; and
a selection section which, in accordance with the number of the actuating elements to be driven concurrently or a printing density of an image to be printed by the recording head, selects at least one from the plurality of series circuits and inputs the generation signal to each input terminal of selected series circuit.

4. The recording head driving device of claim 1, wherein the generation section comprises: a digital waveform generation section, which generates a signal with a standard digital waveform; and an analog waveform generation section, which generates a signal with an analog waveform from the signal generated by the digital waveform generation section.

5. A recording head driving device for driving a recording head at which droplet ejection portions are plurally arranged, the droplet ejection portions including actuating elements which are driven such that droplets are ejected in accordance with driving signals, the recording head driving device comprising:
a digital waveform generation section, which generates a signal with a standard digital waveform;
a plurality of series circuits with output terminals thereof being commonly connected, the plurality of series circuits being structured such that an analog waveform generation section, a voltage amplification section and a current amplification section are connected in series in each circuit, the analog waveform generation section generating a signal with an analog waveform from the signal generated by the digital waveform generation section, the voltage amplification section amplifying a voltage component of the signal generated by the analog waveform generation section, and the current amplification section amplifying a current component of the signal whose voltage component has been amplified by the voltage amplification section and outputting the signal whose current component has been amplified through the output terminal to serve as a driving signal; and
a selection section which, in accordance with the number of the actuating elements to be driven concurrently or a printing density of an image to be printed by the recording head, selects at least one from the plurality of series circuits and inputs the signal generated by the digital waveform generation section to each input terminal of selected series circuit.

6. A printing apparatus comprising:
a recording head at which droplet ejection portions are plurally arranged, the droplet ejection portions including actuating elements which are driven such that droplets are ejected in accordance with driving signals; and
a recording head driving device for driving the recording head which includes
a generation section, which generates a signal with a standard waveform,
a voltage amplification section, which amplifies a voltage component of the signal generated by the generation section,
a plurality of current amplification sections with output terminals thereby being commonly connected, the plurality of current amplification sections outputting a signal, in which a current component of a signal inputted through an input terminal has been amplified, through the output terminals to serve as a driving signal, and
a selection section which, in accordance with the number of the actuating elements to be driven concurrently or a printing density of an image to be printed by the recording head, selects at least one of the plurality of current amplification sections and inputs a signal outputted from the voltage amplification section to each input terminal of selected current amplification section.

7. A recording head driving device for driving actuating elements of a plurality of droplet ejectors, which are structural elements of a recording head, the recording head driving device comprising:
a plurality of current amplification sections with output terminals thereof being commonly connected, the plurality of current amplification sections amplifying a current component of a signal with a standard waveform; and
a selection section connected to each of the plurality of current amplification sections, the selection section selecting at least one of the plurality of current amplification sections in accordance with the number of the actuating elements to be driven concurrently.

8. The recording head driving device of claim 7, further comprising a voltage amplification section which amplifies a voltage component of the standard waveform signal,
wherein the selection section feeds the standard waveform signal whose voltage component has been amplified by the voltage amplification section to at least one of the selected current amplification sections.

9. The recording head driving device of claim 7, further comprising a plurality of voltage amplification sections which amplify a voltage component of the standard waveform signal, the voltage amplification sections being connected respectively to the plurality of current amplification sections,
wherein the selection section is connected, via the plurality of voltage amplification sections, to each of the plurality of current amplification sections.

10. The recording head driving device of claim 7, further comprising a generation section which generates the standard waveform signal,
wherein the selection section feeds the standard waveform signal generated by the generation section to at least one of the selected current amplification sections.

11. The recording head driving device of claim 7, further comprising a plurality of generation sections which generate the standard waveform signal, the generation sections being connected respectively to the plurality of current amplification sections,
wherein the selection section is connected, via the plurality of generation sections, to each of the plurality of current amplification sections.

12. The recording head driving device of claim 10, wherein the generation section comprises: a digital waveform generation section, which generates a signal with a standard digital waveform; and an analog waveform generation section, which generates a signal with an analog waveform from the signal generated by the digital waveform generation section.

13. The recording head driving device of claim 7, further comprising:
a digital waveform generation section, which generates a signal with a standard digital waveform; and
a plurality of analog waveform generation sections, which generate signals with analog waveforms on the basis of the standard digital waveform signal, the analog waveform generation sections being connected respectively to the plurality of current amplification sections,
wherein the selection section is connected, via the plurality of analog waveform generation sections, to each of the plurality of current amplification sections.

14. The recording head driving device of claim 7, wherein the selection section comprises a plurality of switches which are turned on and off in accordance with the number of the actuating elements to be driven concurrently, the plurality of switches being connected respectively to the plurality of current amplification sections,
the selection section is connected to the plurality of current amplification sections by the plurality of switches, and
the selection section selects at least one of the plurality of current amplification sections by the current component of the standard waveform signal being amplified only in at least one of the current amplification sections that are connected to at least one of the switches which are turned on.

15. The recording head driving device of claim 7, wherein current amplification ratios of the plurality of current amplification sections are mutually equal, and total current amplification ratio is determined by the number of the plurality of current amplification sections that are selected by the selection section.

16. The recording head driving device of claim 7, wherein the plurality of current amplification sections includes at least one set of two current amplification sections with mutually differing current amplification ratios, and a total current amplification ratio is determined by a combination of selections of the plurality of current amplification sections that are selected by the selection section.

17. The recording head driving device of claim 7, further comprising a memory section, wherein
correspondences between the numbers of the actuating elements to be driven concurrently and the numbers of selections of the plurality of current amplification sections to be selected by the selection section are memorized at the memory section, and
the selection section selects the at least one of the plurality of current amplification sections in accordance with the number of selections corresponded with the number of the actuating elements, and outputs an inputted signal to at least one of the selected current amplification sections.

18. The recording head driving device of claim 7, further comprising a memory section, wherein
correspondences between the numbers of the actuating elements to be driven concurrently and combinations of selections of the current amplification sections to be selected by the selection section are memorized at the memory section, and
the selection section selects the at least one of the plurality of current amplification sections in accordance with the combination of selections corresponded with the number of the actuating elements, and outputs an inputted signal to at least one of the selected current amplification sections.

19. The recording head driving device of claim 7, further comprising a memory section, wherein
a table in which the numbers of the actuating elements to be driven concurrently correspond with the numbers of selections of the plurality of current amplification sections to be selected by the selection section is memorized at the memory section, and
the selection section selects at least one of the plurality of current amplification sections in accordance with the number of selections which is derived from the table, and outputs an inputted signal to at least one of the selected current amplification sections.

20. The recording head driving device of claim 7, further comprising a memory section, wherein
a table in which the numbers of the actuating elements to be driven concurrently correspond with combinations of selections of the plurality of current amplification sections to be selected by the selection section is memorized at the memory section, and
the selection section selects at least one of the plurality of current amplification sections in accordance with a combination which is derived from the table, and outputs an inputted signal to at least one of the selected current amplification sections.

21. The recording head driving device of claim 7, further comprising a memory section, wherein
a function with variables thereof being the numbers of the actuating elements to be driven concurrently, a function deriving the number of selections of the plurality of current amplification sections to be selected by the selection section from the variables, is memorized at the memory section, and
the selection section selects at least one of the plurality of current amplification sections in accordance with the number of selections derived by the function, and outputs an inputted signal to at least one of the selected current amplification sections.

22. A printing apparatus comprising:
a recording head driving device which includes
a plurality of current amplification sections with output terminals thereof being commonly connected, the plurality of current amplification sections amplify a current component of a signal with a standard waveform, and
a selection section which selects at least one of the plurality of current amplification sections in accordance with the number of actuating elements to be driven concurrently, the selection section being connected to each of the plurality of current amplification sections; and
a recording head which is structured with a plurality of droplet ejectors, which include the actuating elements which are driven by the recording head driving device.
